(19) United States
(12) Patent Application Publication
(10) Pub. No.: US 2008/0010119 A1
(43) Pub. Date: Jan. 10, 2008

(54) LOCATING DOWNLOADED AND VIEWED CONTENT AND ADVERTISEMENTS

(75) Inventors: Eduardo P. Oliveira, Redmond, WA (US); Aamer Hydrie, Seattle, WA (US); John Karl Bresemann, Redmond, WA (US); Gareth Alan Howell, Bothell, WA (US)

Correspondence Address: SENNIGER POWERS (MSFT), ONE METROPOLITAN SQUARE, 16TH FLOOR, ST. LOUIS, MO, 63102, US

(73) Assignee: MICROSOFT CORPORATION, Redmond, WA (US)

(21) Appl. No.: 11/424,213

(22) Filed: Jun. 14, 2006

(51) Int. Cl. G06Q 30/00

(52) U.S. Cl. 705/14

(57) ABSTRACT

Locating previously-viewed content download service. Program content and associated advertisements are downloaded to a computing device associated with a user. Advertisements are selected based on a manifest associated with the program content. The computing device renders the program content with the selected advertisements to the user. Metadata relating to the rendered content is collected. A user searches and selects the content rendered from the computing device.

### BACKGROUND

Consumers have been benefiting from additional freedom and control over the consumption of digital media content. One example is the proliferation of personal video recorder systems (PVRs) that allow consumers to record television shows for later viewing. The adoption of PVRs has furthered interest in on-demand, consumer-driven experiences with content consumption. Examples of existing systems include on-demand digital cable, internet video streaming services, and peer-to-peer distribution networks. Other existing systems include music and video stores providing consumers with content which may be purchased and subsequently viewed on personal video or audio players.

Some existing systems fail to maintain a history of the viewed content. In such systems, users cannot identify the content that has been viewed. While some existing systems do maintain a limited history of the viewed content, these systems fail to persist copies of the viewed content thus preventing users from retrieving content that has been viewed and deleted.

### SUMMARY

Embodiments of the invention enable a user to locate previously-viewed content in a content download service. In an embodiment, the invention maintains a searchable history of viewed content. Program content and advertisements are downloaded from a content download service to a computing device associated with the user for rendering. The computing devices stores metadata associated with the rendering content and enables searching of the metadata by, for example, keyword searching, timeline-based searching, or context-based searching to enable the user to identify and watch previously-viewed content.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary block diagram illustrating a content download system.

FIG. 2 is an exemplary flow chart illustrating dynamic insertion of advertisements into program content at the time of playback.

FIG. 3 is an exemplary flow chart illustrating operation of a system for enabling a user to identify and select previously-viewed content.

FIG. 4 is an exemplary block diagram illustrating a user interface displaying a timeline of previously-viewed content.

Corresponding reference characters indicate corresponding parts throughout the drawings.

### DETAILED DESCRIPTION

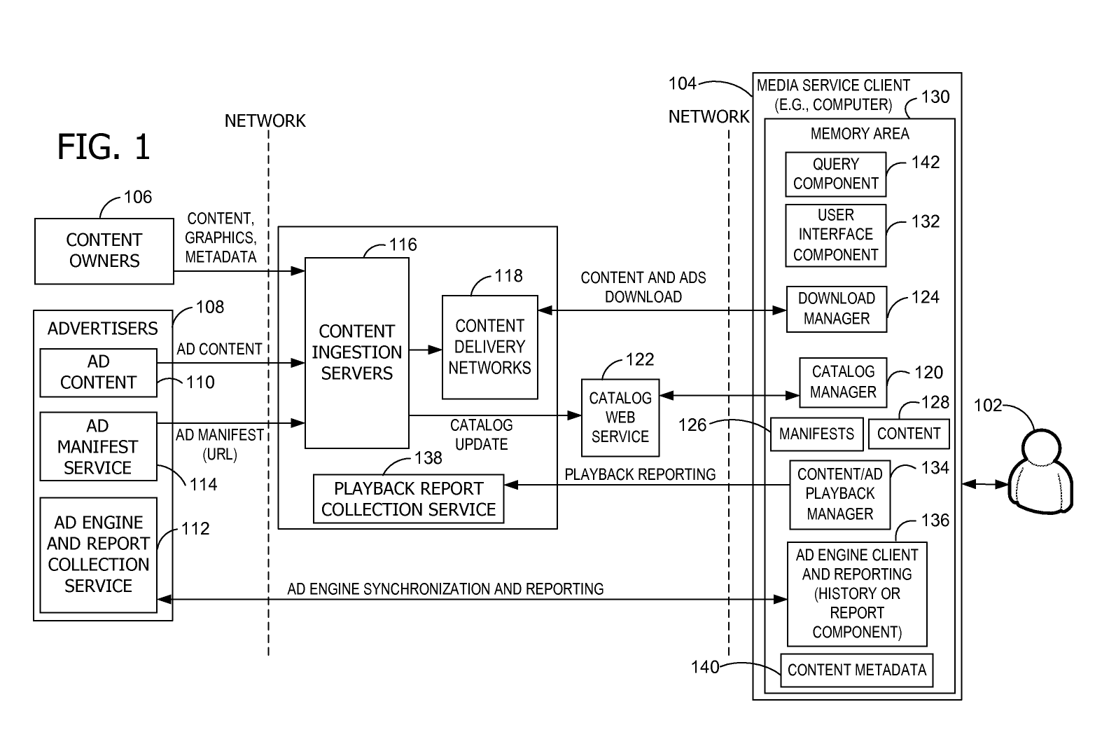

In an embodiment, the invention dynamically selects advertisements for rendering with program content to a user 102 in a content download service such as illustrated in FIG. 1. In addition, aspects of the invention maintain a history of the rendered program content and ads to enable the user 102 to identify and view previously-viewed content. A catalog of programming offers the program content for selection and downloading by the user 102. Aspects of the invention enable the user 102 to consume the downloaded program content and selected advertisements on-the-go while preserving the dynamic selection of advertisements. The relevance and revenue potential of the advertisements is thus increased, while the user experience is enhanced.

Although described primarily in the context of video media files, aspects of the invention may be applied to various forms of digital media, including video and multimedia files (e.g., movies, movie trailers, television shows, etc.), audio files (e.g., music tracks, news reports, audio web logs, audio books, speeches, comedy routines, etc.), media broadcasts (e.g., webcasts, podcasts, audiocasts, videocasts, video blogs, blogcasts, etc.), and images.

Embodiments of the invention make use of targeted advertising as a mechanism for providing program content to consumers free of charge. In contrast to existing systems, the ads are selected dynamically at the time of playback, not at the time of delivery. The selection of which ads to play is based on existing campaigns, targeting information, etc. stored in a manifest. It is possible, for example, to display different ads each time the program content is viewed.

Referring again to FIG. 1, an exemplary block diagram illustrates a media content download system. In one embodiment, the media content download system of FIG. 1 is an Internet on-demand video service that offers a large catalog of program content that may be downloaded by users free of charge (e.g., no subscription fee). The program content and ads (collectively referred to as “content” 128) are always available. For example, the content 128 may be stored on a computing device local to the user such as media service client 104, or archived on a server (e.g., such as owned by content owners 106). Revenue is generated by dynamically associating ads with the program content at playback time. The ads are inserted into the program content at playback time, and as such, may change from viewing to viewing.

The content owners 106 or providers supply program content (e.g., video and/or audio files) with associated metadata. This metadata includes the locations in the video at which ads can be inserted (e.g., ad breaks), and which ads provider is responsible for running the ad campaigns. For example, the ads provider may be identified by a uniform resource locator. One or more ads providers or advertisers 108 sell ads against the ad breaks. The ads providers supply ad content 110. The ads providers also run an ad engine and report collection service 112 for collecting the reports of which ads have been played. Furthermore, the ads providers make available ad manifests via an ad manifest service 114. The ad manifests may be distributed via database, stream, file, or the like. The ad manifests include information about the current ad campaigns including which ads (or groups of ads) should be associated with which types of program content. The ad manifests also include the rules about when the advertising may be shown and on what devices/formats. The ad manifests further include the definition of tracking events for reporting on the advertising playback (e.g., a video ad was played, thus it can be billed).

An example manifest is shown in Appendix B. The exemplary ad manifest in Appendix B is an extensible markup language (XML) representation of the ad campaigns in effect. The exemplary format of this file represents a common format and allows for the expression of a rich set of semantics. The common format enables campaigns from multiple ad providers to be run by the media service client 104 without further specialization of the media service client 104 code. The exemplary manifest data structure comprises a program field, an ad break field, a time field, and a rules field. The program field stores a value corresponding to the identified program content item. The ad break field stores a value corresponding to at least one of the segments associated with the identified program content item. The time field stores a value representing an advertisement duration. The rules field identifies the advertisements associated with the identified program content item.

Content ingestion servers 116 receive the program content supplied by the content owners 106, together with the location of the ad manifests, and publish them in a catalog. This catalog includes information about the program content and includes metadata such as categories, descriptions, duration, etc. Content delivery networks 118 interface with the media service client 104 or other computing device associated with the user 102 to deliver the content 128 including program content and advertisements to the user 102.

The user 102 interfaces with the media service client 104, application, computing device, or the like that provides functionality such as browsing, searching, downloading, managing and consuming the content 128. A catalog manager 120 associated with the media service client 104 downloads the catalog via, for example, a catalog web service 122 and allows the user 102 to browse it in search of content 128. An exemplary catalog is shown in Appendix A. Once an item is selected for download, the corresponding ad manifest is retrieved, for example, by a download manager 124 and stored (e.g., as manifests 126). The ad manifest for each program content includes the information for determining which ads should be downloaded together with the program content. The download manager 124 downloads the selected program content and associated ads. Downloading includes retrieving the program content and associated ads. Downloading may also include receiving the program content and associated ads pushed from another computing device (e.g., pushed from a server at regular intervals).

The download manager 124 also periodically updates the downloaded advertisements to maintain a fresh pool of ads that may be displayed against the selected program content. Maintaining a readily available pool of ads enables offline playback, provides high-quality ad files, and allows for various different ads to be displayed against the selected program content.

For example, in one embodiment, the download manager 124 in the media service client 104 checks each of the downloaded program content items to identify and parse the corresponding ad manifests to determine if the current local pool of ads is fresh. If particular ads are no longer relevant, the ads may be deleted from the local pool, while additional ads may be downloaded to keep the local ad pool fresh.

In one embodiment, one or more computer-readable media or other memory areas such as memory area 130 associated with the media service client 104 have computer-executable components comprising the catalog manager 120, a user interface component 132, the download manager 124, a playback manager 134, and a report component 136. The catalog manager 120 downloads a content catalog from a catalog service. The user interface component 132 displays, to the user 102, at least a portion of the content catalog downloaded by the catalog manager 120. The download manager 124 downloads program content and advertisements associated therewith. The playback manager 134 selects one or more of the advertisements associated with the program content and renders, to the user 102, the program content and the selected advertisements downloaded by the download manager 124. The playback manager 134 updates a playback report collection service 138 with the particular program content and ads rendered to the user 102. In addition, the report component 136 identifies the rendered advertisements to one or more advertisement reporting services such as ad report collection service 112. In an embodiment, the report component 136 performs synchronization functions with the ad engine and report collection service 112.

The memory area 130 also stores or otherwise persists the manifests and content (e.g., the program content and the associated advertisements) downloaded by the download manager 124. In an embodiment, the program content is divided into segments such that ad breaks may be detected. The advertisements are inserted at the ad breaks by the playback manager 134. As such, rendering of the program content is interrupted by the rendering of the advertisements. In an aspect of the invention, the manifest correlates particular ads to particular segments of the program content.

In an embodiment, the history or report component 136 determines and maintains content metadata 140 relating to the rendered program content and selected advertisements. The content metadata 140 is stored or otherwise persisted in the memory area 130. A query component 142, also stored in the memory area 130, enables the user 102 to search the content metadata 140 based on search criteria received from the user 102. In an embodiment, the query component 142 is separate from the media service client 104. For example, the query component 142 may be part of a web browser. The search criteria may include keywords, and may implement text-based searching and context-based searching (e.g., which ads were rendered after a particular segment of particular program content). Locating the previously-viewed content may be accomplished via a graphical or textual timeline, search keywords or categories, or an association between program content and respective ads. Based on the input search criteria, the query component 142 returns search results to the user to help the user 102 identify at least one of the rendered advertisements or program content or program content segment. In addition, targeted advertisements may be placed in association with query terms or results.

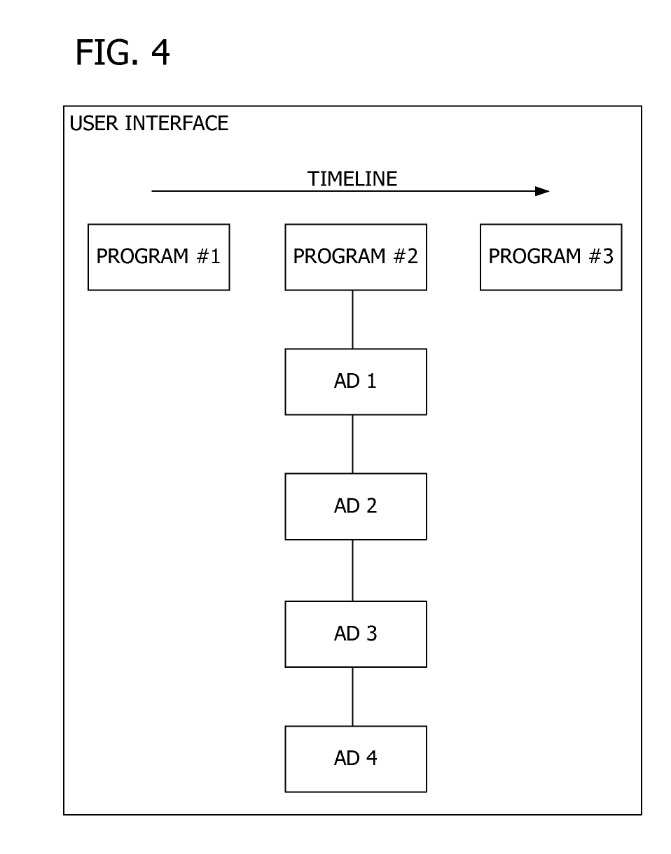

In another embodiment, the user interface component 132 displays a timeline to the user 102 of the rendered program content and associated advertisements such as shown in FIG. 4. The timeline is represented by the content metadata 140 associated with the rendered program content and advertisements. The user 102 navigates the displayed content metadata 140 and selects the desired program content (or program content segment) or advertisement(s) for subsequent viewing. In an embodiment, the user interface component 132 visually distinguishes the displayed content metadata 140 corresponding to content actually viewed by the user 102 from the displayed content metadata 140 corresponding to the content that was rendered to the user 102 but not viewed (e.g., skipped by the user 102). Visually distinguishing includes, for example, highlighting, italicizing, underlining, bolding, or otherwise altering the appearance. In this manner, the user 102 locates previously-viewed content. The playback manager 134 renders the selected content to the user 102, either from a local memory area such as memory area 130 or from a remote server associated with the media content download service that has archived the selected content.

FIG. 1 shows one example of a general purpose computing device in the form of a computer. In one embodiment of the invention, a computing device such as shown in FIG. 1 is suitable for use in the other figures illustrated and described herein. The computer has one or more processors or processing units and access to a memory area such as memory area 130.

The computer typically has at least some form of computer readable media. Computer readable media, which include both volatile and nonvolatile media, removable and non-removable media, may be any available medium that may be accessed by computer. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

In operation, a computing device executes computer-executable instructions such as those illustrated in the figures to implement aspects of the invention.

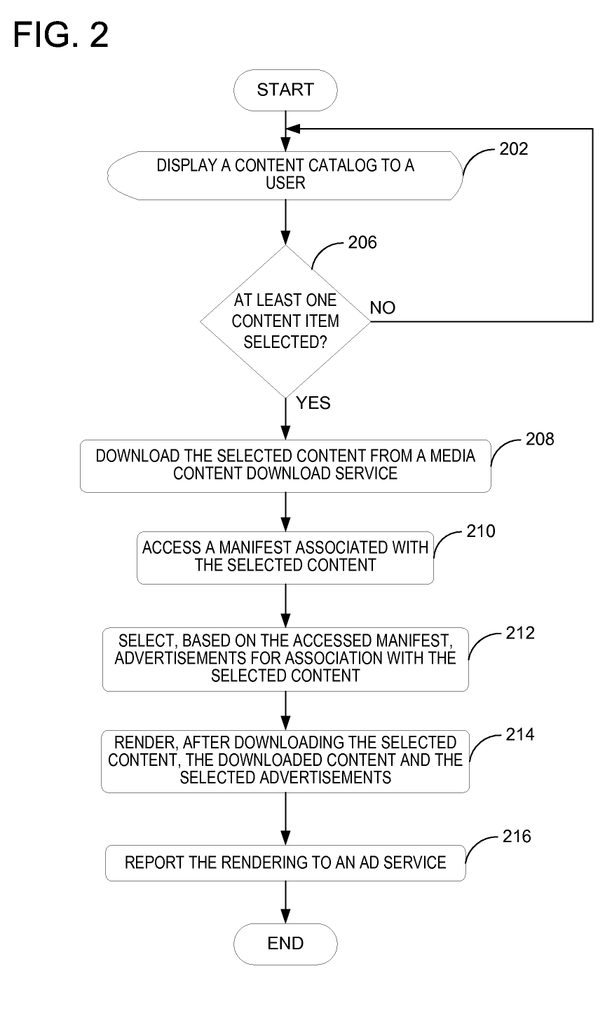

Referring next to FIG.2, an exemplary flow chart illustrates dynamic insertion of advertisements into program content at the time of playback. The user downloads and installs the media service client, application, or the like. The catalog is downloaded or otherwise displayed or made available to the user at 202. The user browses through the catalog. If the user selects at least one content item from the catalog at 206, the media service client downloads the selected content from the media content download service at 208 and accesses a manifest associated with the selected content at 210. The manifest is interpreted as to determine the pool of ads to be downloaded, and the determined ads are downloaded. In another embodiment, the manifest is accessed prior to the download of the program content such that the selected program content and the determined ads are downloaded together (but the particular ads for insertion into the program content are not selected and inserted until the playback time of the program content).

At playback of the program content, the user selects the particular program content to be rendered. The media service client selects, based on the manifest associated with the selected, particular program content, ads to be inserted into the program content at 212. The ads are selected from the downloaded pool of ads. The media service client renders the selected program content with the selected ads inserted therein at 214. The rendering is reported to an ad service at 216.

In an embodiment, the operations in FIG.2 apply to the insertion of video ads into video program content. In other embodiments, the operations in FIG. 2 further apply to the insertion of audio ads into audio program content, wherein the predetermined entry points for the ads (e.g., the ad insertion breaks) occur on the boundaries of songs akin to broadcast radio.

In one embodiment, one or more computer-readable media have computer-executable instructions for performing the method illustrated in FIG. 2.

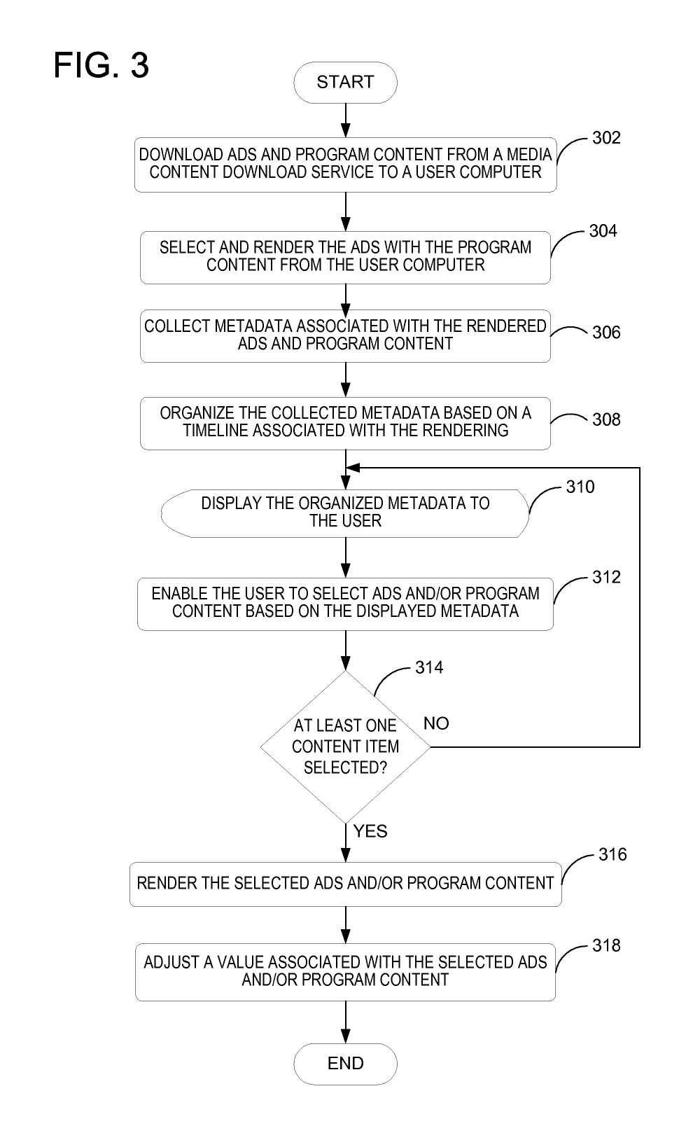

Referring next to FIG. 3, an exemplary flow chart illustrates operation of a system for enabling a user to identify and select previously-viewed content. In an embodiment, the media service client implements the operations illustrated in FIG. 3. The media service client downloads the ads and program content from the media content download service to a computing device associated with the user (e.g., a user computer) at 302. The media service client selects and renders the ads with the program content from the computing device at 304. For example, the ads are sequenced into the program content. For example, a first segment of the program content may be rendered, following by two ads and a second segment of the program content.

Metadata associated with the rendered ads and program content is determined and/or collected at 306. Exemplary metadata for each of the content items (e.g., ads or program content) includes one or more of the following: an identifier associated with the content item, a time associated with the rendering of the content, and a duration of the rendering of the content item. Other exemplary metadata include information such as which ads were displayed against which programs, whether or not the ads were skipped, and whether the user provided a rating to the program content or ads. Other exemplary metadata includes a program content identifier (e.g., the content item that a particular ad is associated with), an identifier of an ad played immediately prior and/or after the content item, a name of a product or service associated with the content item, a hyperlink to the ad, a thumbnail image, a description, and a last time played.

The media service client sorts, orders, prioritizes, or otherwise organizes the content items into a timeline (e.g., based on a rendering time associated with each of the content items) at 308. As an example, FIG. 4 illustrates a timeline of program content and associated ads. The organized or sorted metadata (or a portion thereof) is displayed to the user at 310 in, for example, a user interface. The media service client enables the user to select ads or program content based on the displayed metadata at 312. If the user selects at least one of the content items at 314, the media service client renders the selected content items at 316. If the selected content items are not available on the user's computing device, the selected content items are downloaded from the media content download service. A value associated with the selected content item (or a product category associated with the selected content item) is adjusted at 318. The value may correspond to the number of viewings of the content item by the user, or to a monetary value associated with the content item. For example, the value may be incremented by one each time the ad is selected and rendered. Alternatively or in addition, values associated with ads may be decremented each time an ad is skipped (e.g., not viewed) by the user.

In an embodiment, the content items are sorted in the user interface based on one or more of the following: a user preference, a user viewing habit, a storage location of the rendered content items, a category associated with the rendered content items, a time associated with the rendered content items, and a duration of rendering for each of the content items.

Alternatively or in addition, the user may tag, select, or otherwise provide input corresponding to one of the rendered advertisements. During the display of the metadata corresponding to the rendered content, the metadata corresponding to the tagged advertisement is visually distinguished to the user. Visually distinguishing includes, for example, highlighting the advertisement, displaying the advertisement metadata in a prominent portion of the display, underlining or bolding the advertisement metadata, or the like. This allows the user to tag advertisements of interest for additional viewing. In an embodiment, content that is supplemental or related to the rendered advertisement is downloaded from the media content download service. The supplemental content includes, for example, a longer, full-featured advertisement presenting more product details. The supplemental content is available for rendering to the user at, for example, the completion of the currently rendered program content, or during an ad-insertion break.

In one embodiment, one or more computer-readable media have computer-executable instructions for performing the method illustrated in FIG. 3.

Although described in connection with an exemplary computing system environment, embodiments of the invention are operational with numerous other general purpose or special purpose computing system environments or configurations. The computing system environment illustrated in FIG. 1 is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, PoP devices, mobile telephones, network PCs, minicomputers, mainframe computers, distributed computing environments that include any of the above systems or devices, and the like.

The following examples further illustrate embodiments of the invention. The figures, description, and examples herein as well as elements not specifically described herein but within the scope of aspects of the invention constitute means for running an advertisement campaign associated with a media content download service in which advertisements are inserted into the program content during rendering, and means for enabling the user to select and view previously-viewed advertisements in the media content download service.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

A portion of an exemplary content catalog is shown below.

```
<catalog xmlns:xsi=“http://www.w3.org/2001/XMLSchema-instance”
    xmlns:xsd=“http://www.w3.org/2001/XMLSchema”
    xmlns=“http://tempuri.org/XMLSchema.xsd”>
  <add>
  <channel id=“9feel 1b3-862e-465c-af98-751552bd81f9” title=“Channel 1” reducedTitle=“Ch1”
    description=“” reducedDescription=“” imageUrl=“http://demo/ch1.png” />
  <channel id=“416058a2-72ea-4a27-a038-d8fd0b05b165” title=“Channel 2” reducedTitle=“Ch2”
    description=“” reducedDescription=“” imageUrl=“http://demo/ch2.png” />
  <channel id=“24314381-7d1b-428e-972a-d14f67469e30” title=“Channel 3” reducedTitle=“Ch3”
    description=“” reducedDescription=“” imageUrl=“http://demo/ch3.png” />
  <channel id=“e7e2f9dd-a3ab-4104-b619-e5af1c8b3b0f” title=“Other” reducedTitle=“Other”
    description=“” reducedDescription=“” imageUrl=“http://demo/other.png” />
  <channel id=“babaf485-fde2-43ba-98d3-b4fae917d65a” title=“Science Fiction”
    reducedTitle=“Sci” description=“” reducedDescription=“” imageUrl=“http://demo/sci.png” />
  <series id=“2508f2b4-c35b-4e1b-a5c9-d02b6fd43295” channelId=“9fcel 1b3-862e-465c-af98-
    751542bd81f9” numberOfSeasons=“2” title=“Night Suspense” reducedTitle=“Night
    Suspense” description=“Night Suspense was a mystery and suspense anthology hosted by a
    master of suspense. Each 30 minute episode included opening and closing vingettes
    explaining some aspect of the day's show and would often offer subtle (or not so subtle) jabs
    at the shows sponsors. ” reducedDescription=“Night Suspense was a mystery and suspense
    anthology” imageUrl=“http://demo/ns_series.jpg” />
  <series id=“2a8a7945-48f0-4c3d-95e9-10cddfc6c62c” channelId=“426058a2-72ea-4a27-a038-
    d8fd0b05b165” numberOfSeasons=“3” title=“Alyssa” reducedTitle=“Alyssa”
    description=“Alyssa was first seen in August of 1976 and centered around Alyssa Smith.
    Alyssa works as a waitress in a greasy spoon until her dream of going to Hollywood comes
    true.” reducedDescription=“Alyssa was first seen in August of 1976”
    imageUrl=“http://demo/alys_series.jpg” />
  <series id=“ed400d23-0a6c-49fe-97e4-3d449245b3d1”channelId=“baaaf485-fde2-43ba-98d3-
    b4fae917d65a” numberOfSeasons=“3” title=“Babel X” reducedTitle=“Babel X”
    description=“Babel X brought many exciting innovations to science fiction television.
    Computer-generated effects, five-year story arcs, and elaborate mythology made this series
    stand apart from what came before and point the next generation of sci-fi/fantasy series in
    bold new directions.” reducedDescription=“Babel X brought many exciting innovations to
    science fiction” imageUrl=“http://demo/baby_series.jpg” />
  <program id=“1a267843-c395-4c72-a8e2-f50dd7a46e8f” channelId=“e9e2f9dd-a3ab-4104-b619-
    e5af1c6b3b0f” title=“07-14-2005 Edition” reducedTitle=“07-14-2005 Edition”
    description=“This is a description of this particular episode of Kudlow & Company.”
    reducedDescription=“This is a description of this particular episode of Kudlow & Company.”
    imageUrl=“http://demo/kudl_program1.jpg” contentUrl=“http://demo/kudl_paid.wmv”
    runtimeSeconds=“34” spokenLanguage=“en” creationYear=“2005” originalAirDate=“2005-
    11-02T06:30:00” popularityIndex=“267” requiredDiskBytes=“1656000”
    programType=“Series” purchasePrice=“99”>
  <episodeInfo seriesId=“4c38c130-9c3a-4cd0-b9a5-db8a018294f4” season=“4”
    episodeNumber=“125” />
<ratings>
<rating value=“TV-G(US Television)” />
  </ratings>
<adBreaks>
<adBreak breakPointMsec=“0”
    adManifestUrl=“http://demo/ADSAdClient31.dll?GetAd?PG=MAALX2”
    adGroupId=“GROUP1” />
<adBreak breakPointMsec=“17270”
    adManifestUrl=“http://demo/ADSAdClient31.dll?GetAd?PG=MAALX2”
    adGroupId=“GROUP1” />
<adBreak breakPointMsec=“29070”
    adManifestUrl=“http://demo/ADSAdClient31.dll?GetAd?PG=MAALX2”
    adGroupId=“GROUP1” />
<adBreak breakPointMsec=“41270”
    adManifestUrl=“http://demo/ADSAdClient31.dll?GetAd?PG=MAALX2”
    adGroupId=“GROUP1” />
  </adBreaks>
<contributors>
<contributor contributorName=“Ray Smith” role=“Guest star” />
<contributor contributorName=“Frances Jones” role=“Guest star” />
  </contributors>
<playbackReporting format=“SimpleGet” uri=“http://reporting/playreport.aspx?cid=cf06c288-
    4623-4ecb-9702-0e565b21b26d” />
  </program>
<program id=“7bc60ad1-eb88-4d24-8c8e-837fc292a7a9” channelId=“9fcel 1b3-862e-465c-af98-
    751552bd71f9” title=“Psychic” reducedTitle=“Psychic” description=“A famous pianist
    returns to his home town to find the man who murdered his father only to find out that he
    himself is the killer.” reducedDescription=“A famous pianist returns to his home town to find
    the man who murdered his fathe” imageUrl=“http://demo/alfr_program2.jpg”
    contentUrl=“http://demo/alfr.wmv” runtimeSeconds=“53” spokenLanguage=“en”
    creation Year=“1955” originalAirDate=“1955-10-09T06:30:00” popularityIndex=“239”
    requiredDiskBytes=“1656000” programType=“Series” purchasePrice=“0”>
<episodeInfo seriesId=“2508e2b4-c35b-4e1b-a5c9-d02b6fd43295” season=“1”
    episodeNumber=“2” />
<ratings>
<rating value=“TV-G(US Television)” />
  </ratings>
<adBreaks>
<adBreak breakPointMsec=“0”
    adManifestUrl=“http://ADSAdClient31.dll?GetAd?PG=MAALX2” adGroupId=“GROUP1”
    />
<adBreak breakPointMsec=“17270”
    adManifestUrl=“http://ADSAdClient31.dll?GetAd?PG=MAALX2” adGroupId=“GROUP1”
    />
>adBreak breakPointMsec=“29070”
    adManifestUrl=“http://ADSAdClient31.dll?GetAd?PG=MAALXS” adGroupId=“GROUP1”
    />
<adBreak breakPointMsec=“41270”
    adManifestUrl=“http://ADSAdClient31.dll?GetAd?PG=MAALX2” adGroupId=“GROUP1”
    />
  </adBreaks>
<contributors>
<contributor contributorName=“Tom Shelton” role=“Guest star” />
<contributor contributorName=“Terry Shala” role=“Guest star” />
  </contributors>
<playbackReporting format=“SimpleGet” uri=“http://reporting/playreport.aspx?cid=7bc60ad1-
    eb86-4d24-8c8e-837fc292a7a9” />
  </program>
```

An exemplary manifest is shown below.

```
    <?xml version=“1.0” ?>
- <Manifest Timestamp=“2005-12-20T00:00:00” SchemaVersion=“1”>
- <Ads HousePriority=“60”>
- <Ad ID=“2853997” ConditionGroupID=“1115192” Priority=“20”>
- <Goals>
  <GoalRotation Percent=“13” Start=“2005-12-21T00:00:00” End=“2006-06-07T07:59:59” />
    </Goals>
- <AdCreatives>
  <AdCreative CreativeID=“813621” Start=“2005-12-06T18:00:00” End=“2006-06-07T08:00:00”
      Weight=“1” />
    </AdCreatives>
    </Ad>
- <Ad ID=“2853998” ConditionGroupID=“1115192” Priority=“20”>
- <Goals>
  <GoalRotation Percent=“13” Start=“2005-12-21T00:00:00” End=“2006-06-07T07:59:59” />
    </Goals>
- <AdCreatives>
  <AdCreative CreativeID=“813619” Start=“2005-12-06T18:00:00” End=“2006-06-07T08:00:00”
      Weight=“1” />
    </AdCreatives>
    </Ad>
- <Ad ID=“2853999” ConditionGroupID=“1115192” Priority=“20”>
- <Goals>
  <GoalRotation Percent=“13” Start=“2005-12-21T00:00:00” End=“2006-06-07T07:59:59” />
    </Goals>
- <AdCreatives>
  <AdCreative CreativeID=“813620” Start=“2005-12-06T18:00:00” End=“2006-06-07T08:00:00”
      Weight=“1” />
    </AdCreatives>
    </Ad>
- <Ad ID=“2878254” ConditionGroupID=“1115192” Priority=“20”>
- <Goals>
  <GoalRotation Percent=“13” Start=“2005-12-21T00:00:00” End=“2006-06-08T07:59:59” />
    </Goals>
- <AdCreatives>
  <AdCreative CreativeID=“820569” Start=“2005-12-21T01:00:00” End=“2006-06-08T08:00:00”
      Weight=“1” />
    </AdCreatives>
    </Ad>
- <Ad ID=“2878407” ConditionGroupID=“1115192” Priority=“20”>
- <Goals>
  <GoalRotation Percent=“12” Start=“2005-12-21T00:00:00” End=“2006-06-08T07:59:59” />
    </Goals>
- <AdCreatives>
  <AdCreative CreativeID=“820567” Start=“2005-12-21T01:00:00” End=“2006-06-08T08:00:00”
      Weight=“1” />
    </AdCreatives>
    </Ad>
- <Ad ID=“2878408” ConditionGroupID=“1115192” Priority=“20”>
- <Goals>
  <GoalRotation Percent=“13” Start=“2005-12-21T00:00:00” End=“2006-06-08T07:59:59” />
    </Goals>
- <AdCreatives>
  <AdCreative CreativeID=“820568” Start=“2005-12-21T01:00:00” End=“2006-06-08T08:00:00”
      Weight=“1” />
    </AdCreatives>
    </Ad>
- <Ad ID=“2878409” ConditionGroupID=“1115192” Priority=“20”>
- <Goals>
  <GoalRotation Percent=“13” Start=“2005-12-21T00:00:00” End=“2006-06-08T07:59:59” />
    </Goals>
- <AdCreatives>
  <AdCreative CreativeID=“820570” Start=“2005-12-21T01:00:00” End=“2006-06-08T08:00:00”
      Weight=“1” />
    </AdCreatives>
    </Ad>
- <Ad ID=“2878410” ConditionGroupID=“1115192” Priority=“20”>
- <Goals>
  <GoalRotation Percent=“13” Start=“2005-12-21T00:00:00” End=“2006-06-08T07:59:59” />
    </Goals>
- <AdCreatives>
  <AdCreative CreativeID=“820571” Start=“2005-12-21T01:00:00” End=“2006-06-08T08:00:00”
      Weight=“1” />
    </AdCreatives>
    </Ad>
- <Ad ID=“2878547” ConditionGroupID=“1115192” Priority=“60”>
- <Goals>
  <GoalConstant Start=“2005-12-20T17:00:00” End=“2006-06-08T07:00:00”/>
    </Goals>
- <AdCreatives>
  <AdCreative CreativeID=“820572” Start=“2005-12-21T01:00:00” End=“2006-06-08T07:00:00”
      Weight=“1” />
    </AdCreatives>
    </Ad>
    </Ads>
- <Conditions>
- <ConditionGroup ID=“1115192”>
  <Condition Name=“PG” Eval=“eq” Value=“AD0001” />
    </ConditionGroup>
    </Conditions>
- <Creatives>
- <Creative ID=“813620” EventSetID=“1”>
  <Media Format=“1001”
      URI=“http://videod1.preview.microsoft.com/download/2b/d2/83/7b7fa4e5-2718-4402-97fc-
      ea425983d22b.wmv” SizeBytes=“837388” DurationMS=“30000” />
    </Creative>
- <Creative ID=“813621” EventSetID=“1”>
<Media Format=“1001”
      URI=“http://videod1.preview.microsoft.com/download/d1/3b/57/be372e96-24dd-458d-8447-
      a9c16f573bd1.wmv” SizeBytes=“4581380” DurationMS=“30000” />
    </Creative>
- <Creative ID=“813619” EventSetID=“1”>
  <Media Format=“1001”
      URI=“http://videod1.preview.microsoft.com/download/10/ae/fb/25c217a7-38a0-409e-9f50-
      6195aafbae10.wmv” SizeBytes=“2469308” DurationMS=“15000” />
    </Creative>
- <Creative ID=“820569” EventSetID=“1”>
  <Media Format=“1001”
      URI=“http://videod1.preview.microsoft.com/download/a8/07/3b/518ac1ff-a546-403d-afa4-
      e4f1503b07a8.wmv” SizeBytes=“4831976” DurationMS=“31000”/>
    </Creative>
- <Creative ID=“820567” EventSetID=“1”>
  <Media Format=“1001”
      URI=“http://videod1.preview.microsoft.com/download/af/7e/7f/4aa26afa-a677-4531-a25b-
      333a7b7f7eaf.wmv” SizeBytes=“4741410” DurationMS=“31000” />
    </Creative>
- <Creative ID=“820568” EventSetID=“1”>
  <Media Format=“1001”
      URI=“http://videod1.preview.microsoft.com/download/05/4a/ff/a3c49856-b21c-42b3-922d-
      37b4ffff4a05.wmv” SizeBytes=“2461330” DurationMS=“16000” />
    </Creative>
- <Creative ID=“820570” EventSetID=“1”>
  <Media Format=“1001”
      URI=“http://videod1.preview.microsoft.com/download/d7/d6/74/381d9b53-f413-43ed-bc75-
      1853c674d6d7.wmv” SizeBytes=“2405324” DurationMS=“16000” />
    </Creative>
- <Creative ID=“820571” EventSetID=“1”>
  <Media Format=“1001”
      URI=“http://videod1.preview.microsoft.com/download/97/b3/1c/4dccfcc3-7f6f-4414-8685-
      3ce4fb1cb397.wmv” SizeBytes=“4525404” DurationMS=“30000” />
    </Creative>
- <Creative ID=“820572” EventSetID=“1”>
  <Media Format=“1001”
      URI=“http://videod1.preview.microsoft.com/download/39/ba/99/bf37ccd6-b2fc-4a6d-a604-
      25495199ba39.wmv” SizeBytes=“4613406” DurationMS=“31000” />
    </Creative>
    </Creatives>
- <Events>
- <EventSet ID=“1” ImpressionEvent=“PL”>
  <Event Type=“PL”
      URI=“http://adservice.recording.microsoft.com/{CreativeID}.1?X&&PID={AdID}&TargetI
      D={ConditionGroupID}&AN={RandomNumber}&PG={AdGroup}” />
<Event Type=“DT”
      URI=“http://adservice.recording.microsoft.com/{CreativeID}.2?X&&PID={AdID}&TargetI
      D={ConditionGroupID}&AN={RandomNumber}&PG={AdGroup}” />
<Event Type=“ET”
      URI=“http://adservice.recording.microsoft.com/{CreativeID}.3?X&&PID={AdID}&TargetI
      D={ConditionGroupID}&AN={RandomNumber}&PG={AdGroup}” />
<Event Type=“IM”
      URI=“http://adservice.recording.microsoft.com/{CreativeID}.4?X&&PID={AdID}&TargetI
      D={ConditionGroupID}&AN={RandomNumber}&PG={AdGroup}” />
    </EventSet>
    </Events>
    </Manifest>
```

What is claimed is:

1. A method comprising:
downloading, from a media content download service to a computing device associated with the user, a plurality of content items including advertisements and program content;
rendering at least a portion of the downloaded program content with selected advertisements to a user;
determining metadata associated with each of the rendered content items;
displaying at least a portion of the determined metadata to the user, said displayed portion of the determined metadata corresponding to the rendered content items;
enabling the user to select at least one of the content items based on the displayed metadata; and
rendering the selected content items.

2. The method of claim 1, wherein rendering the portion of the downloaded program content and selected advertisements comprises rendering, in a sequence, the portion of the downloaded program content and selected advertisements, and further comprising organizing the displayed metadata based on the sequence.

3. The method of claim 1, further comprising rendering additional, selected, downloaded advertisements during the rendering of the selected content items.

4. The method of claim 1, further comprising increasing a value associated with the rendered, selected content items by reporting the rendering of the selected content items to an advertisement reporting service.

5. The method of claim 1, further comprising ordering the determined metadata based on one or more of the following: a user preference, a user viewing habit, a storage location of the rendered content items, a category associated with the rendered content items, a time associated with the rendered content items, and a duration of rendering for each of the content items.

6. The method of claim 1, wherein the metadata for each of the content items comprises one or more of the following: an identifier associated with the content item, a time associated with the rendering of the content, and a duration of the rendering of the content item.

7. The method of claim 1, wherein rendering the at least a portion of the downloaded program content with selected advertisements to a user comprises rendering, to the user, at least a portion of the downloaded program content with advertisements selected based on a manifest associated with the program content.

8. The method of claim 1, further comprising storing the downloaded plurality of content items on the computing device associated with the user

9. The method of claim 1, wherein rendering the selected content items comprises rendering, from the computing device, the selected content items.

10. The method of claim 1, further comprising identifying the selected, downloaded content items to an advertisement service.

11. The method of claim 1, further comprising:
receiving input from the user during the rendering of the downloaded program content and selected advertisements, said received input corresponding to one of the rendered advertisements; and
visually distinguishing metadata representing said one of the rendered advertisements during said displaying.

12. The method of claim 11, further comprising:
downloading, from the media content download service to the computing device, a content item associated said one of the rendered advertisements; and
rendering the downloaded content item to the user.

13. The method of claim 1, wherein one or more computer-readable media have computer-executable instructions for performing the method recited in claim 1.

14. A system comprising:
a memory area for storing a plurality of content items downloaded from a media content download service, said plurality of content items including advertisements and program content, said memory area further storing metadata associated with each of the downloaded content items; and
a processor configured to execute computer-executable instructions for:
downloading, from the media content download service, the plurality of content items;
storing the downloaded plurality of content items in the memory area;
rendering at least a portion of the program content with selected advertisements from the memory area to a user;
identifying metadata associated with the rendered program content and selected advertisements, said identified metadata comprising a rendering time associated with the program content and each of the selected advertisements;
ordering the identified metadata based on the rendering time;
displaying, to the user, at least a portion of the ordered metadata;
receiving, from the user, a selection of the displayed metadata, said received selection corresponding to at least one of the rendered advertisements; and
rendering the corresponding advertisement to the user.

15. The system of claim 14, further comprising means for enabling the user to select and view previously-viewed advertisements in the media content download service.

16. The system of claim 14, wherein the processor is further configured to execute computer-executable instructions for downloading the corresponding advertisement from the media content download service if the corresponding advertisement is no longer stored in the memory area.

17. One or more computer-readable media having computer-executable components for locating previously watched content and ads, said components comprising:
a download manager for downloading program content and advertisements associated therewith from a media content download service to a user;
a playback manager for selecting one or more of the advertisements associated with the program content and rendering, to the user, the program content and the selected advertisements downloaded by the download manager;
a history component for determining and maintaining metadata relating to the rendered program content and selected advertisements; and
a query component for searching the metadata maintained by the history component based on search criteria received from the user to identify at least one of the rendered advertisements, wherein the playback manager renders the identified advertisement to the user.

18. The computer-readable media of claim 17, further comprising a user interface component for displaying at least a portion of the metadata maintained by the history component to the user, said displayed portion of the metadata corresponding to the program content and selected advertisements rendered by the playback manager.

19. The computer-readable media of claim 18, wherein the user views one or more of the selected advertisements rendered by the playback manager, and wherein the user interface component visually distinguishes the displayed metadata corresponding to the viewed advertisements from the displayed metadata corresponding to the other advertisements.

20. The computer-readable media of claim 17, wherein the search criteria relates to one or more of the following: a timeline of the program content and selected advertisements rendered by the playback manager, an association with the program content rendered by the playback manager, and text-based keywords.
